(19) United States
(12) Patent Application Publication
(10) Pub. No.: US 2001/0016622 A1
(43) Pub. Date: Aug. 23, 2001

(54) Sulfonic acid compounds, processes for the preparation thereof and use thereof

(76) Inventors: Rainer Blum, Ludwigshafen (DE); Ulrike Hees, Mannheim (DE); Roman Benedikt Raether, Limburgerhof (DE)

Correspondence Address: Herbert B. Keil, KEIL & WEINKAUF, 1101 Connecticut Ave., N.W., Washington, DC, 20036, US

(21) Appl. No.: 09/777,848

(22) Filed: Feb. 7, 2001

(30) Foreign Application Priority Data
Feb. 9, 2000 (DE) 10005650.4
Feb. 9, 2000 (DE) 10005648.2

(51) Int. Cl. C08K 3/20; C08G 18/00

(52) U.S. Cl. 524/591; 528/44

(57) ABSTRACT

The present invention relates to a sulfonic acid compound of the formula I

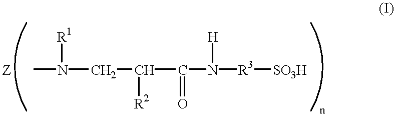

in which n is a number from 1 to 1 000 000, at least one of the radicals R¹ is R⁴—QH, R⁴—Q—(X—O—)ₘX—QH or R⁴—O—Y—QH, and m is a value from 1 to 300, the radicals R², independently of one another, are in each case H or a linear or branched, saturated or unsaturated aliphatic hydrocarbon radical, a saturated or unsaturated, optionally substituted cycloaliphatic hydrocarbon radical, an optionally substituted aliphatic hydrocarbon radical or an optionally substituted aromatic hydrocarbon radical, the radicals R³ are a linear or branched, saturated or unsaturated alkyl radical or cycloalkyl radical, Z is a linear or branched, saturated or unsaturated optionally substituted alkyl radical, a cycloalkyl radical, an araliphatic hydrocarbon radical or a polyether, a polyester, a polyamide, a polycarbonate, a polyurethane or a polylactone, where Z is bonded to the whole molecule via suitable functional groups, or a partial or complete salt thereof, and to the preparation and use thereof.

The invention relates to a sulfonic acid compound of the formula I

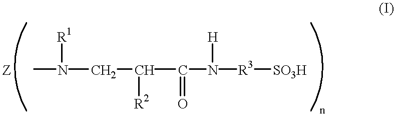

in which n is a number greater than 1 to 2, or is 1, or more than 2 to 1 000 000, at least one of the radicals R¹ is R⁴—QH, R⁴—Q—(X—O—)ₘX—QH or R⁴—O—Y—QH, where Q is O, NH, NR² or S, R⁴ is a linear or branched, saturated or unsaturated alkyl radical having 2 to 44 carbon atoms, X is an optionally substituted alkyl radical having 2 to 40 carbon atoms, Y is a polymer, obtainable by polymerization, polyaddition or polycondensation, having a molecular weight M_{w} of from 150 to 5000, and m is a value from 1 to 300, where in the case of n>2, R¹ may also be H, CH₃, a linear or branched, saturated or unsaturated alkyl radical having 2 to 44 carbon atoms or a cycloalkyl radical having 4 to 44 carbon atoms or an aromatic hydrocarbon radical having 6 to 10 carbon atoms, the radicals R², independently of one another, are in each case a linear or branched, saturated or unsaturated aliphatic hydrocarbon radical having 1 to 20 carbon atoms or a cycloaliphatic hydrocarbon radical having 4 to 20 carbon atoms or an optionally substituted aromatic hydrocarbon radical having 6 to 18 carbon atoms, the radicals R³ are a linear or branched, saturated or unsaturated alkyl radical having 2 to 44 carbon atoms or a saturated or unsaturated cycloalkyl radical having 6 to 44 carbon atoms, Z, if n>1, is a linear or branched, saturated or unsaturated optionally substituted alkyl radical having 8 to 44 carbon atoms, an optionally substituted cycloalkyl radical having 4 to 44 carbon atoms, an optionally substituted araliphatic hydrocarbon radical having 6 to 40 carbon atoms or a polyether, a polyester, a polyamide, a polycarbonate, a polyurethane or a polylactone having a molecular weight M_{w} of from 150 to 10 000, where Z is bonded to the whole molecule via suitable functional groups, and if n=1, R¹ and Z, in each case independently of one another, are R⁴—QH, RW—Q—(X—O—)ₘX—QH or R⁴—O—Y—Q—, where Q is O, NH, NR⁴ or S, R⁴ is a linear or branched, saturated or unsaturated, optionally aromatically substituted alkyl radical having 2 to 44 carbon atoms, X is an alkyl radical having 2 to 10 carbon atoms, Y is a polymer obtainable by polymerization, polyaddition or polycondensation and having a molecular weight M_{w} of from 150 to 5000, and m is a value from 1 to 300, and where the two radicals R¹ and Z are not CH₂—CH₂—OH at the same time, or a partial or complete salt thereof.

Compounds, for example polymers, which contain sulfonic acid groups have a broad spectrum of possible applications. They are used in organic chemistry and in polymer chemistry particularly when the compounds used are to have particular dispersion properties since the sulfonic acid group is known for its excellent dispersing action. However, it is frequently problematical to provide a simple procedure for incorporating sulfonic acid groups into polymers which, in particular, ensures that the sulfonic acid group incorporated in the polymer satisfies the desired properties in as optimum and tailored a manner as possible.

Thus, for example, U.S. Pat. No. 5,695,884 describes a thermoplastic polyurethane which has at least one sulfonate group. The sulfonate group is incorporated into the polyurethane via a corresponding, sulfonate-containing polyester polyol, the sulfonic acid group being integrated into the polyester polyol in the form of a sulfophthalic acid derivative. A problem of such polyurethanes is that the sulfonate group, because of the rigid phthalic acid body to which it is bonded, only provides limited mobility, which frequently has a negative effect on the dispersion properties of the corresponding polyurethane. Moreover, following incorporation into the polyurethane, such sulfonate groups are located directly in the main chain, as a result of which flexibility and mobility of the main chain may be restricted.

DE-C 34 0 7 563 describes an alternative method of introducing sulfonic acid groups into polyaddition and polycondensation products. In this method, a diol which carries two terminal OH groups and is terminally unsaturated is converted to a terminal sulfonate by the bisulfite addition reaction. The sulfonate is then incorporated into a polyurethane, for example, via the two OH groups. Although this method avoids the disadvantage of the sulfonate group on a rigid backbone being directly attached to the main chain, the method described and the compounds obtainable thereby do, however, likewise have a number of disadvantages. Thus, for example, it is disadvantageous that the bisulfite addition reaction must usually take place in an aqueous environment. Moreover, the bisulfite addition reaction is usually the last processing stage prior to incorporation into a polymer, meaning that adequate dewatering is in some cases impaired.

If a relatively hydrophobic diol is used in this environment for the bisulfite addition reaction, then isolation of the reaction product is usually difficult. For this reason, use is usually made in such reactions of hydrophilic compounds, for example the polyethers described in said publication. Although such sulfonated polyethers can then be incorporated into polymeric compounds, they, firstly, contribute nothing to the flexibilization of the main chain, and secondly, because of the reaction conditions during the conversion, the hydrophilicity of the side chain carrying the sulfonate group can only be varied within narrow limits.

There was therefore a need for compounds carrying sulfonic acid groups which can be incorporated into polymers both via polyaddition and also via polycondensation reactions, where the flexibilization of the main chain and also the flexibility of the side chain carrying the sulfonate group can be varied within wide limits. DE-B 19 54 090 describes a process for the preparation of 2-(β-aminopropionamido)alkanesulfonic acid salts and their use as anionic formative component in the preparation of polyurethane dispersions. A disadvantage of the substances described therein is that incorporation into a polyurethane is only possible via an amino group. However, the polyureas which form in the process have a number of properties which are disadvantageous for their applications as polymeric surfactants or for the dispersion of solids in a polymer matrix. Moreover, the compounds described can only be processed in an aqueous phase, thus restricting the freedom of the person skilled in the art with regard to formulation. Processing of the polyureas in organic solvents with low polarity is generally not possible.

WO 91/06597 relates to curable aminoplastic compounds and catalysts for the curing thereof. It describes very diverse reaction products, such as those which are obtainable from the reaction of primary or secondary amines and a vinyl or allyl compound which carries a sulfonate group. By way of example, the reaction with 2-acrylamido-2-methylpropanesulfonic acid (AMPS) is carried out using a very wide variety of amines. However, the publication does not mention any compounds which can be incorporated into polyurethanes and which can contribute both to the control of the hydrophilicity and also to the flexibilization of the main chain.

DE-A 26 56 687 relates to aminodi- and aminopolyalkylamidoalkanesulfonic acids, to processes for the preparation thereof and to the use thereof. However, the compounds described are not suitable for incorporation into polymers.

U.S. Pat. No. 4,985,591 describes the preparation of semicrystalline catalysts for the curing of coatings, an isocyanate-sulfonate being prepared by Michael addition and subsequent chain extension with an isocyanate. The use of such compounds as surfactants or the incorporation thereof into polymers is not, however, described therein.

Accordingly, it is an object of the present invention to provide sulfonic-acid-containing compounds which are preferably themselves excellent dispersants, but are, however, also suitable for the incorporation of sulfonic acid groups into polymers, it being possible to modify the compounds in a simple manner such that, for example, the flexibility of the main chain, the flexibility of the side chain carrying the sulfonic acid group, and the degree of hydrophilicity of the compound can be varied. Furthermore, such compounds should have good dispersing properties and, where they are used for the incorporation of anionic groups into polymers, impart such properties to the polymer resulting therefrom. Moreover, the corresponding sulfonic-acid-containing compounds should have considerable variability with regard to the adjustability of the solubility parameters.

We have found that this object is achieved by sulfonic acid compounds of the type described below.

The present invention therefore provides sulfonic acid compounds of the formula I

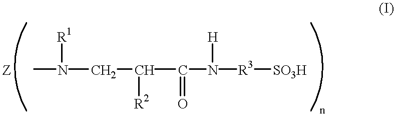

in which n is a number greater than 1 to 2, at least one of the radicals R¹ is R⁴—QH, Re—Q—(X—O—)ₘX—QH or R⁴—O—Y—QH, where Q is O, NH, NR² or S, R⁴ is a linear or branched, saturated or unsaturated alkyl radical having 2 to 44 carbon atoms, X is an optionally aromatically substituted alkyl radical having 2 to 14, especially 2 to 10 carbon atoms, Y is a polyester, a polyamide, a polycarbonate, a polyurethane or a polylactone having a molecular weight M_{w} of from 150 to 5000, and m is a value from 1 to 300, the radicals R², independently of one another, are in each case H or a linear or branched, saturated or unsaturated aliphatic hydrocarbon radical having 1 to 20 carbon atoms or a saturated or unsaturated, optionally substituted cycloaliphatic hydrocarbon radical having 4 to 20 carbon atoms an optionally substituted aliphatic hydrocarbon radical having 6 to about 20 carbon atoms or an optionally substituted aromatic hydrocarbon radical having 6 to 18, especially 6 to 10 carbon atoms, the radicals R³ are a linear or branched, saturated or unsaturated alkyl radical having 2 to 44 carbon atoms or a saturated or unsaturated cycloalkyl radical having 6 to 44 carbon atoms, Z is a linear or branched, saturated or unsaturated optionally substituted alkyl radical having 8 to 44 carbon atoms, an optionally substituted cycloalkyl radical having 4 to 44 carbon atoms, an optionally substituted araliphatic hydrocarbon radical having 6 to 40 carbon atoms or a polyether, a polyester, a polyamide, a polycarbonate, a polyurethane or a polylactone having a molecular weight M_{w} of from 150 to 10 000, where Z is bonded to the whole molecule via suitable functional groups, or a partial or complete salt thereof.

The present invention thus further provides sulfonic acid compounds of the formula I

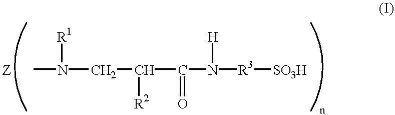

in which n is a number of more than 2 to 100 000, the radicals R¹, in each case independently of one another, are H, CH₃, a linear or branched, saturated or unsaturated alkyl radical having 2 to 44 carbon atoms or a cycloalkyl radical having 4 to 44 carbon atoms or an aromatic hydrocarbon radical having 6 to 10 carbon atoms, R⁴—QH, R⁴—Q—(X—O—)ₘX—QH or R⁴—O—Y—QH, where Q is O, NH, NR² or S, R⁴ is a linear or branched, saturated or unsaturated alkyl radical having 1 to 44 carbon atoms, and X, Y, m, R², R³ and Z have the meanings given in claim 1.

The present invention thus likewise provides a sulfonic acid compound of the formula I

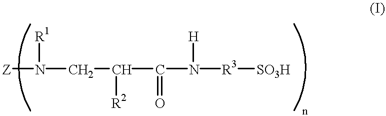

in which n is 1, R² is H or a linear or branched, saturated or unsaturated aliphatic hydrocarbon radical having 1 to 20 carbon atoms, a saturated or unsaturated, optionally substituted cycloaliphatic hydrocarbon radical having 4 to 20 carbon atoms or an optionally substituted araliphatic hydrocarbon radical having 6 to 40 carbon atoms, R³ is a linear or branched, saturated or unsaturated aliphatic hydrocarbon radical having 1 to 20 carbon atoms or a cycloaliphatic hydrocarbon radical having 4 to 20 carbon atoms or an optionally substituted aromatic hydrocarbon having 6 to 18 carbon atoms, R¹ and Z, in each case independently of one another, are R⁴—QH, R⁴—Q—(X—O—)ₘX—QH or R⁴—O—Y—QH, where Q is O (oxygen), NH, NR⁴ or S, R⁴ is a linear or branched, saturated or unsaturated, optionally aromatically substituted alkyl radical having 2 to 44 carbon atoms, X is an optionally aromatically substituted alkyl radical having 2 to 14 carbon atoms, Y is a polymer, obtainable by polymerization, polyaddition or polycondensation, having a molecular weight M_{w} of from 150 to 5000 and m is a value from 1 to 300 and where the two radicals R¹ and Z are not CH₂—CH₂—OH at the same time, or a salt thereof.

For the purposes of the present text, “sulfonic acid compound” is understood as meaning a compound of the formula I which carries at least one sulfonic acid group, the term “sulfonic acid compound” also, however, including the partial and complete salts of such sulfonic acids. Salts is understood as meaning, for example, the reaction products of the claimed sulfonic acids with bases, it being possible for the bases to be either of an inorganic nature or else of an organic nature. Examples of corresponding salts are the salts of the alkali metals, such as lithium, sodium, potassium, rubidium or cesium, or the salts of the alkaline earth metals, such as magnesium, calcium or strontium. However, for the purposes of the present invention, in addition to said salts with inorganic compounds, salts of the abovementioned sulfonic acids with organic bases are also suitable. In a preferred embodiment of the present invention, salts of the abovementioned sulfonic acids are understood as meaning salts with amino compounds. Particularly suitable amino compounds are aliphatic and aromatic amino compounds, such as, for example, pyridines, alkanolamines or trialkylamines, the corresponding alkyl radicals, independently of one another, having 1 to about 22 carbon atoms. In a further preferred embodiment, the invention relates to salts of the abovementioned sulfonic acids with pyridines, alkanolamines or trialkylamines whose alkyl radicals, independently of one another, have 1 to about 5 carbon atoms. For the purposes of the present invention, “partial salt” is understood as meaning a salt of a compound of the formula I in which not all of the sulfonic acid groups are present in salt form. In the case of a complete salt, all of the sulfonic acid groups are in salt form.

The molecular weights given in this text have the unit g/mol, unless stated otherwise. Molecular weights of compounds which have a random molecular weight distribution have been determined by GPC. For this, use was made of the following materials:

column material: PL gel 5 micrometers 2×500 Angstr. 1×1000 1×10 000

eluting agent: THF 1 ml/min

pump: Waters model 510

autosampler: Waters model 717

UV detector: Waters Lambda-Max 481

RI detector: Waters model 410

In a preferred embodiment of the present invention, the radicals R¹, or for the case n=1 also the radical Z, in each case have at least two carbon atoms. The number of carbon atoms does not necessarily refer to carbon atoms bonded covalently with one another in a chain, but the present invention also includes those sulfonic acid compounds whose radicals R¹, or for the case n=1 also the radical Z, in each case contain at least two carbon atoms which are not directly covalently bonded, but, for example, are bonded with one another via a further atom, such as O or N.

For the purposes of the present invention, the radicals R¹, or for the case n=1 also the radical Z, have in total at least one QH group, in which Q has the meaning given above. In a preferred embodiment of the present invention, the number of QH groups in the radicals R¹, or for the case n=1 also the radical Z, can, independently of the others, be, for example, 1 to about 8, in particular 1 to about 4. In a further preferred embodiment of the invention, the number of QH groups in the radicals R¹, or for the case n=1 also the radical Z, is 1, 2 or 3. Here, the QH groups may be located either only on one of the radicals R¹ or for the case n=1 also the radical Z, although it is equally possible for the QH groups to be located on two or more radicals R¹, or for the case n=1 also the radical Z, or on both if the compound of the formula I has more than one radical R¹ or Z. In a preferred embodiment of the invention, each of the radicals R¹, or for the case n=1 also the radical Z, in each case has at least one QH group.

In a further preferred embodiment of the invention, Q is O.

In a preferred embodiment of the invention, the radicals R¹, or if n=1 also Z, independently of one another, are R⁴—QH, RW—Q—(X—O—)ₘX—QH or R⁴—O—Y—QH, where Q is O (oxygen), NH, NR⁴ or S, in particular R⁴—OH, R⁴—O—(X—O—)ₘ—H or R⁴—O—Y—QH, in which R⁴ is a linear or branched, saturated or unsaturated, optionally aromatically substituted alkyl radical having 2 to about 44 carbon atoms or a substituted or unsubstituted aromatic hydrocarbon radical having 6 to about 10 carbon atoms, X is an alkyl radical with or without aromatic substituents having 2 to 14, in particular 2 to 10, carbon atoms, Y is a polymer obtainable by polymerization, polyaddition or polycondensation, in particular a polyester, a polyamide, a polycarbonate, a polyurethane or a polylactone having a molecular weight M_{w} of from 150 to 5000, for example about 200 to about 4000 or about 500 to about 3000 or about 800 to about 2000 or about 1000 to about 1600, and m is a value from 1 to about 300, for example a value of from 3 to 150 or from 10 to 70, where, in the case n=1, the two radicals R¹ and Z are not CH₂—CH₂—OH at the same time.

In a further preferred embodiment of the invention, R⁴ is a linear or branched, saturated, optionally aromatically substituted alkyl radical having 2 to about 10, in particular 3 to about 8, carbon atoms.

If R¹, or if n=1 also Z, is R⁴—Q—(X—O)ₘX—QH, in particular R⁴—O—(X—O)ₘ—H, then X, in a preferred embodiment of the invention, is a saturated, linear or branched alkyl radical having 2 to 4, in particular 2 or 3, carbon atoms or an aromatic, substituted, linear or branched alkyl radical having in total 8 to about 18 carbon atoms. R¹, or if n=1 also Z, is then a polyether chain whose molecular weight M_{w} depends firstly on X, but primarily on the value of m. In a preferred embodiment of the invention, m is a value from 1 to about 200, in particular from about 3 to about 150, for example about 5 to about 50. If the value of m is greater than 1, then X can be a variety of alkyl radicals whose number of carbon atoms is within the range already given above. In the case of larger values of m, for example in a range of from about 5 to about 100, the various alkyl radicals X can be arranged in random order or arbitrarily blockwise behind one another. The value m does not necessarily have to be an integer, m can just as equally assume arbitrary values between two integers within the range given above. If m is a fraction, then it represents an average value, as arises in the course of customary polyether syntheses because of the random distribution of molecular weights during the polyaddition. In a further preferred embodiment of the invention, X is CH₂—CH₂ or CH(CH₃)—CH₂ or CH₂—CH(CH₃) or a random or blockwise sequence of these radicals.

Polyethers of the type mentioned above can, for example, be obtained by polymerization of ethylene oxide, propylene oxide, butylene oxide, tetrahydro-furan, styrene oxide or epichlorohydrin with themselves, e.g. in the presence of basic catalysts, such as sodium methoxide, potassium methoxide, sodium ethoxide, potassium ethoxide, sodium hydroxide, potassium hydroxide or BF₃, or by the addition of said compounds, optionally in a mixture or one after the after, to starting components having reactive hydrogen atoms, such as alcohols or amines, e.g. water, diethylene glycol, 1,2-propanediol, 1,3-propanediol, 1,2-bis(4-hydroxydiphenyl)propane or aniline.

In a further preferred embodiment of the present invention, the radical R¹, or if n=1, R¹ or Z, or both, is R⁴—Q—Y—QH, in particular R⁴—O—Y—OH. Y is a polyester, a polyamide, a polycarbonate or a polylactone having a molecular weight M_{w} of from about 200 to about 4000, for example about 300 to about 3000 or about 500 to about 2000 or about 800 to about 1500. In a further preferred embodiment of the invention, said polymers are linear polymers.

Suitable polyesters can be obtained, for example, by polycondensation of linear or branched, aliphatic or cycloaliphatic, saturated or unsaturated diols with linear or branched, saturated or unsaturated, aliphatic or cycloaliphatic dicarboxylic acids or with aromatic dicarboxylic acids. Suitable diols are, for example, ethylene glycol, 1,2-propanediol, 1,3-propanediol, 1,3-butanediol, 1,4-butanediol, 1,4-butenediol, 1,4-butynediol, 1,5-pentanediol, neopentyl glycol, bis(hydroxy-methyl)cyclohexanes, such as 1,4-bis(hydroxymethyl)cyclohexane, 2-methylpropane-1,3-diol, methylpentanediols, diethylene glycol, triethylene glycol, tetraethylene glycol, dipropylene glycol, dibutylene glycol, and further higher oligomers of said glycols, mixed oligomers also being suitable. For the purposes of the present invention, preference is given to polyesters whose preparation has been carried out using alcohols of the formula HO—(CH₂)ₓ—OH, in which x is a number from 2 to about 44, for example an even number of from about 2 to about 20. Examples of such alcohols are ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, or 1,12-dodecanediol, or mixtures of two or more thereof.

Examples of suitable dicarboxylic acids are dicarboxylic acids of the formula HOOC—(CH₂)_{y}—COOH, where y is a number from 1 to about 20, for example an even number of from 2 to about 20. Examples of such dicarboxylic acids are succinic acid, adipic acid, dodecanedicarboxylic acid and sebacic acid. Also suitable as acids for constructing the abovementioned polyesters are suberic acid, azelaic acid, phthalic acid, isophthalic acid, phthalic anhydride, tetrahydrophthalic anhydride, hexahydrophthalic anhydride, tetrachlorophthalic anhydride, endo-methylenetetrahydrophthalic anhydride, glutaric anhydride, maleic acid, maleic anhydride, fumaric acid or dimer fatty acids, or mixtures of two or more thereof.

In a preferred embodiment of the present invention, the polyesters used have a molecular weight of from about 150 to about 1500, especially preferred from about 150 to about 300.

For the purposes of the present invention, polyamides suitable as radical Y can, for example, be prepared by reacting the abovementioned dicarboxylic acids with corresponding diamines. Suitable diamines are, for example, those with a molecular weight of from about 32 to about 200 g/mol and having at least two primary, two secondary or one primary and one secondary amino groups.

Examples thereof are diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or, optionally in small amounts, diamines, such as dietylenetriamine or 1,8-diamino-4-aminomethyl-octane. The polyamides which can be used for the purposes of the present invention have, in a preferred embodiment, a molecular weight of from about 100 to about 1500.

Also suitable as diols for constructing corresponding polyesters are polycarbonatediols, as are obtainable, for example, by reacting phosgene with an excess of the abovementioned diols.

The polycarbonates suitable as radical Y for the purposes of the present invention correspond to the polycarbonates already given above, as are obtainable, for example, by reacting phosgene with one or a mixture of two or more of the abovementioned diols. In a preferred embodiment of the invention, the polycarbonates have a molecular weight of from about 100 to about 10 000, for example about 100 to about 5000, preferably about 200 to about 1500 and in particular about 200 to about 800.

Polyurethanes suitable as radical Y for the purposes of the present invention can be obtained, for example, by customary reactions known to the person skilled in the art of polyisocyanates with polyols or similar compounds which are reactive toward polyisocyanates under polycondensation. Compounds suitable for the preparation of such polyurethanes are described, for example, in the text below. Polyurethanes suitable as radical Y for the purposes of the present invention have, for example, a molecular weight of at least about 100 to about 4000, for example about 200 to about 3000, in particular from about 300 to about 2000 or about 500 to about 1500. For the purposes of the present text, a polyurethane is understood as meaning a compound which has at least two urethane groups per molecule. Also suitable as polyurethanes are, for example, those polyurethanes as presented for the purposes of the present invention.

According to the invention, also suitable for use as radical Y are polylactones, as are obtainable by homo- or copolymerization of lactones, optionally in the presence of a suitable, difunctional starter molecule. Suitable lactones are preferably those derived from compounds of the formula HO—(CH₂)_{z}—COOH, where z is a number from 1 to about 20. Examples are ε-caprolactone, β-propiolactone, γ-butyrolactone or methyl-ε-caprolactone or mixtures of two or more thereof. Preferred polylactones used for the purposes of the present invention have a molecular weight of from about 100 to about 1500, in particular about 200 to about 800.

For the purposes of the present invention, it is not necessary for the radicals R¹ in the compounds of the formula to be identical. Each of the radicals R¹ can, independently of possible further radicals R¹ present in the molecule, be a radical as has been defined above. Likewise, for the case where n=1, for the purposes of the present invention it is not necessary for R¹ and Z to be identical.

For the purposes of the present invention, the radical R² is H or a linear or branched, saturated or unsaturated aliphatic hydrocarbon radical having 1 to about 30 carbon atoms, preferably having 1 to about 20 carbon atoms, a saturated or unsaturated, optionally substituted cycloaliphatic hydrocarbon radical having 4 to about 30 carbon atoms, preferably having 1 to about 20 carbon atoms, an optionally substituted araliphatic or aliphatic hydrocarbon radical having 6 to about 40 carbon atoms, preferably having 6 to about 20 carbon atoms, or an optionally substituted aromatic hydrocarbon radical having 6 to 40 carbon atoms, in particular having 6 to about 18 carbon atoms. Within the given ranges, the radical R² can be chosen such that the claimed sulfonic acid compound satisfies, for example, a certain solubility profile, for example in connection with its preparation or its subsequent use, or can be tailored with regard to another property which is dependent on the presence of certain alkyl chains within the molecule to a corresponding application. In a preferred embodiment of the present invention, the radical R² is hydrogen or a linear or branched, saturated hydrocarbon radical having 1 to about 16, in particular 1 to 6, carbon atoms. In a further preferred embodiment of the invention, the radical R² is hydrogen or CH₃ or phenyl.

For the purposes of the present invention, the radical R³ is a linear or branched, saturated or unsaturated aliphatic hydrocarbon radical having 1 to about 30 carbon atoms and a cycloaliphatic hydrocarbon radical having 4 to about 30 carbon atoms.

As well as the effect on the solubility parameters which has already been described in the course of the explanations relating to radical R², a change of the radical R³ can, within the scope of the present invention, also be used to vary the flexibility and the distance of the sulfonic acid group from the remainder of the molecule, in particular when the sulfonic acid compounds according to the invention are incorporated into a polymer. In a preferred embodiment of the invention, the radical R³ is a linear or branched aliphatic hydrocarbon radical having 3 to 8 carbon atoms.

For the purposes of the present embodiment, the radical Z is a linear or branched, saturated or unsaturated optionally substituted alkyl radical having 8 to 44 carbon atoms, an optionally substituted cycloalkyl radical having 4 to 44 carbon atoms, an optionally substituted araliphatic hydrocarbon radical having 6 to 40 carbon atoms or a polyether, a polyester, a polyamide, a polycarbonate, a polyurethane or a polylactone having a molecular weight M_{w} of from 150 to 1500, where Z is bonded to the whole molecule via suitable functional groups. Functional groups suitable for the bonding to the whole molecule are, in principle, those functional groups which are able to react with the corresponding nitrogen atom in the formula I to form a covalent bond. Examples of such functional groups are NCO groups, epoxy groups, carboxylic acid groups, carboxylic anhydrides, carbonyl chlorides and the like. The radical Z is then, for example, —(O)C—Z¹—C(O)—, —(O)C—HN—Z¹—HN—C(O)—, H₂—C—CH(OH)—Z¹—CH(OH)—CH₂— and the like, where Z¹ is a linear or branched, saturated or unsaturated optionally substituted alkyl radical having 8 to 44 carbon atoms, an optionally substituted cycloalkyl radical having 4 to 44 carbon atoms, an optionally substituted araliphatic hydrocarbon radical having 6 to 40 carbon atoms or a polyether, a polyester, a polyamide, a polycarbonate, a polyurethane or a polylactone having a molecular weight M_{w} of from 150 to 5000.

Suitable as polyester, polyamide, polycarbonate, polyurethane or polylactone having a molecular weight M_{w} of from 150 to 5000 are the compounds already mentioned and explained above in the explanation of the radical R¹.

Since the intention with the compounds according to the invention is to provide sulfonic acid compounds which can also be processed in nonaqueous solution, in particular in a solvent which is largely free from protic constituents, the definition given above undergoes a considerable restriction. Namely, if in the case n=1 one of the two radicals R¹ and Z has 2 carbon atoms and one QH group, the remaining radical must have at least 3 carbon atoms.

For the purposes of a first embodiment of the invention, the parameter n is a number greater than 1 and less than 2 or is 2. In particular, n is a number from about 1.3 to about 1.99, for example about 1.5 to about 1.8 or in a preferred embodiment of the invention about 1,8 to about 2.

In a second embodiment, n is 1.

In a further embodiment of the invention, n is a number of more than 2 up to about 1 000 000, in particular a number from about 2.1 to about 10 000 or about 2.5 to about 100 or about 2.8 to about 20. In a further embodiment, n is especially about 2 to about 6. Suitable compounds in which n is one of the numbers given above are, for example, polyethylenimines or polyvinylamines or polyacrylates or -methacrylates carrying amino groups.

Compounds which are particularly suitable for the purposes of the present invention have, for example, a structure according to the formulae Ia or Ib below:

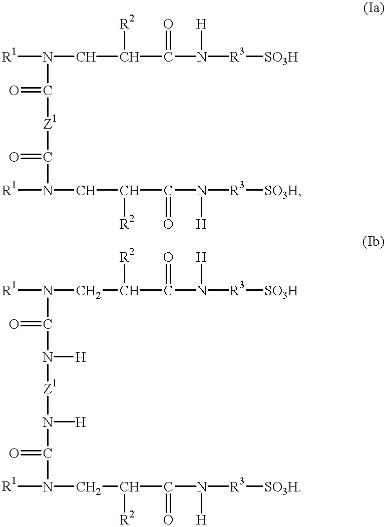

The sulfonic acid compounds according to the invention can be prepared in various ways according to the principles of organic chemistry.

For example, it is possible to prepare the compounds according to the invention by reacting corresponding components A and B in the sense of a Michael addition. Then, according to a preferred embodiment, a further reaction with an at least difunctional component C can take place.

The invention thus also provides a process for the preparation of a sulfonic acid compound according to the formula I, in which a compound of the formula II

R¹—NHZ³ (II),

or a mixture of two or more such compounds, in which R¹ is as defined above, and Z³ can be H or Z, where Z is as defined for the case when n=1, as component A, is reacted with a compound of the formula III

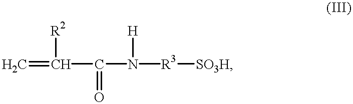

or a mixture of two or more such compounds, in which R² and R³ are as defined above, as component B. In a preferred embodiment, the reaction product is reacted with a compound of the formula V

Z¹(—L)ₙ (V),

as component C, in which Z¹ and n are as defined above, and L is an NCO, epoxy, carboxylic acid, carbonyl chloride or carboxylic anhydride group, to give a compound of the formula I.

If the compound of the formula III (component B) is used in the process as the acid, then component A should preferably be used at least in molar excess.

Compounds of the formula II (component A) can be prepared according to generally known principles of organic chemistry. The starting point for the preparation of such molecules is usually the compound NH(R³OH)₂, which, for example for the preparation of the abovementioned polyethers, is reacted with corresponding alkylene oxides, as already described above. Analogously, as a result of the condensation reaction of this compound with correspondingly functionalized polyesters, polyamides, polycarbonates or polylactones, it is possible to obtain a molecule of the formula II.

In a first embodiment of the preparation process according to the invention, an amine, in particular a monoamine, of the formula II is therefore reacted with an ethylenically unsaturated amidosulfonic acid compound, preferably an imidosulfonic acid compound of the formula III, under suitable conditions.

The reaction can be carried out with or without solvents. Examples of suitable solvents are alcohols, such as methanol, ethanol, isopropyl alcohol, ethers, such as ethylene glycol, dimethyl ether or tetrahydrofuran, ketones, such as acetone or methyl ethyl ketone (MEK), N-methylpyrrolidone (NMP), N,N-dimethylformamide (DMF), acetonitrile, trichloromethane or toluene, or mixtures of two or more thereof. In addition to the abovementioned solvents, in particular together with the abovementioned polar solvents, water may optionally be present in the solvent mixture during the reactions. If the compounds according to the invention are to be used for the preparation of essentially anhydrous polymers, then it is preferable, for the purposes of the present invention, to carry out the reaction in the absence of water. In this case, particularly preferred solvents are tetrahydrofuran, acetone or methyl ethyl ketone or a mixture of two or more thereof. The reaction temperature is between about 0° C. and about 200° C. Good results can be achieved, for example, in a temperature range of from about 20° C. to about 90° C. The reaction can, where appropriate, be accelerated by the addition of a basic catalyst. Suitable basic catalysts are, for example, triethylamine, pyridine, benzyltrimethylammonium hydroxide, sodium hydroxide or potassium hydroxide.

Optionally, a polymerization inhibitor may also be present in the reaction mixture during the reaction. Suitable polymerization inhibitors are, for example, hydroquinone monomethyl ether, stable radicals, such as 2,2,6,6-tetramethylpiperidinyl-1-oxyl radical (TEMPO) or 2,2,6,6-tetramethyl-4-hydroxypiperidinyl-1-oxyl radical (TEMPOL), polymerization inhibitors from the group of sterically hindered amines (HALS) or from the group of nitroxides.

The sulfonic acid compounds according to the invention have, according to the formula I, at least one OH—, NH₂—, NHR²— or SH group in at least one of the radicals R¹, and, depending on the parameter n, more than one sulfonic acid group or a salt of a sulfonic acid group. Because of the variation possibilities, which have already been largely described above, with regard to the hydrophilicity of the sulfonic acid compounds according to the invention and the flexibility thereof, and also the molecular weight, the sulfonic acid compounds according to the invention are suitable for incorporation into polyaddition or polycondensation products.

The present invention thus also provides a polyaddition or polycondensation product which has at least one structural unit of the formula IV

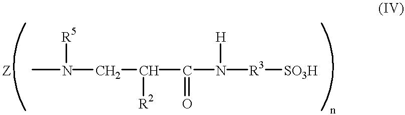

in which the radicals R⁵, in each case independently of one another, are R⁴—Q—, R⁴—Q—(X—O—)ₘX—Q— or R⁴—O—Y—Q, where Q is O, NH, NR² or S, and n is a number greater than 1, especially about 1 to about 1000000, R⁴ is a linear or branched, saturated or unsaturated alkyl radical having 2 to 44 carbon atoms, X is an alkyl radical having 2 to 10 carbon atoms, Y is a polyester, a polyamide, a polycarbonate, a polyurethane or a polylactone having a molecular weight M_{w} of from 150 to 5000 and m is a value of from 1 to 300, the radicals R², independently of one another, are in each case a linear or branched, saturated or unsaturated aliphatic hydrocarbon radical having 1 to 20 carbon atoms or a cycloaliphatic hydrocarbon radical having 4 to 20 carbon atoms or an optionally substituted aromatic hydrocarbon radical having 6 to 10 carbon atoms, the radicals R³ are a linear or branched, saturated or unsaturated alkyl radical having 2 to 44 carbon atoms or a saturated or unsaturated cycloalkyl radical having 6 to 44 carbon atoms, Z is a linear or branched, saturated or unsaturated optionally substituted alkyl radical having 8 to 44 carbon atoms, an optionally substituted cycloalkyl radical having 4 to 44 carbon atoms, an optionally substituted araliphatic hydrocarbon radical having 6 to 40 carbon atoms or a polyether, a polyester, a polyamide, a polycarbonate, a polyurethane or a polylactone having a molecular weight M_{w} of from 150 to 10 000, where Z is bonded to the whole molecule via suitable functional groups, or a partial or complete salt thereof.

The radicals R⁵ thus essentially correspond to the above definition for R¹, taking into account the fact that a linkage to the polymer chain with elimination of an H atom has taken place.

The present invention thus likewise provides a polyaddition or polycondensation product which has at least one structural unit of the formula IVa

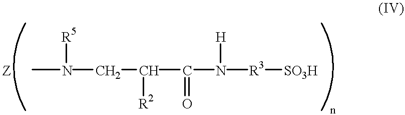

in which n is 1, R² is H or a linear or branched, saturated or unsaturated aliphatic hydrocarbon radical having 1 to 20 carbon atoms, a saturated or unsaturated, optionally substituted cycloaliphatic hydrocarbon radical having 4 to 20 carbon atoms or an optionally substituted araliphatic or aromatic hydrocarbon radical having 6 to 40 carbon atoms, R³ is a linear or branched, saturated or unsaturated aliphatic hydrocarbon radical having 1 to 20 carbon atoms or a cycloaliphatic hydrocarbon radical having 4 to 20 carbon atoms or an optionally substituted aromatic hydrocarbon having 6 to 18 carbon atoms, Z² and R⁵, in each case independently of one another, are R⁴—Q—, R⁴—Q—(X—O—)ₘX—Q— or R⁴—O—Y—Q—, where Q is O (oxygen), NH, NR⁴ or S, R⁴ is a linear or branched, saturated or unsaturated, optionally aromatically substituted alkyl radical having 2 to 44 carbon atoms, X is an optionally aromatically substituted alkyl radical having 2 to 14 carbon atoms, Y is a polymer obtainable by polymerization, polyaddition or polycondensation and having a molecular weight M_{w} of from 150 to 5000 and m is a value of from 1 to 300 and where the two radicals Z² and R⁵ are not CH₂—CH₂—OH at the same time, or a salt thereof.

The radicals Z² and R⁵ thus essentially correspond to the above definition for R¹ and Z, taking into account the fact that a linkage to a polymer chain has taken place. Moreover, the structural unit of the formula IV also includes those polyaddition or polycondensation products in which the radicals Z² and R⁵ each have only 2 carbon atoms.

For the purposes of the present invention, a “polymer” is understood as meaning a polyaddition or polycondensation product. A polymer for the purposes of the present invention can have a molecular weight which is lower than that of the structural unit of the formula IV or IVa. It may, however, also have an essentially identical molecular weight or a molecular weight above that of the structural unit of the formula IV or IVa. In a preferred embodiment of the present invention, the polymer has a molecular weight above the molecular weight of the structural unit of the formula IV or IVa.

The polyaddition products include, for example, the reaction products of the sulfonic acid compounds according to the invention with compounds which can undergo a polyaddition reaction with an OH group. These include, for example, the epoxy group and the isocyanate group. Polycondensation products within the meaning of the invention are reaction products of the sulfonic acid compounds according to the invention having functional groups which are able to undergo a condensation reaction with OH groups. Examples of such functional groups are carboxylic acids or carbonyl chlorides.

In a preferred embodiment of the invention, the polyaddition and polycondensation products are polyurethanes, polyesters, polyethers, polycarbonates, polyether esters, polyamides, polyester amides, polyether amides, polylactones or polylactams.

The present invention therefore also provides for a process for the preparation of a polyaddition or polycondensation product according to the invention which comprises reacting, under suitable reaction conditions, a compound of the formula I, in which R¹, R², R³ and Z are as defined, and a compound or a mixture of two or more compounds which are able to react together with the compound of the formula I to give a polyaddition or polycondensation product.

The reaction of the sulfonic acid compounds according to the invention with the corresponding functional groups in the course of a polyaddition or a polycondensation is carried out in accordance with the general principles of organic chemistry or of polymer chemistry.

In a particularly preferred embodiment of the present invention, the polyaddition product is a polyurethane. Polyurethanes can be obtained by reaction of the OH-group-carrying sulfonic acid compounds according to the invention with polyisocyanates, for example diisocyanates or triisocyanates. Suitable as isocyanates are monomeric, low molecular weight polyisocyanates and also prepolymers carrying isocyanate groups.

Suitable monomeric polyisocyanates are, in particular, the diisocyanates of the formula X(NCO)₂, where X is an aliphatic hydrocarbon radical having 4 to about 12 carbon atoms, a cycloaliphatic or aromatic hydrocarbon radical having 6 to about 15 carbon atoms or an aliphatic hydrocarbon radical having 7 to about 15 carbon atoms. Examples of such diisocyanates are tetramethylene diisocyanate, hexamethylene diisocyanate, dodecamethylene diisocyanate, 1,4-diisocyanato-cyclohexane, 1-diisocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane, or mixtures of two or more of said compounds.

Suitable as mixtures of these isocyanates are, in particular, the mixtures of their respective structural isomers of diisocyanatotoluene and diisocyanatodiphenyl-methane, in particular the mixture of 80 mol % of 2,4-diisocyanatotoluene and 20 mol % of 2,6-diisocyanatotoluene. In addition, mixtures of aromatic polyisocyanates, such as 2,4-diisocyanatotoluene and 2,6-diisocyanatotoluene, with aliphatic or cycloaliphatic polyisocyanates, such as hexamethylene diisocyanate or IPDI, are particularly advantageous, the preferred mixing ratio of the aliphatic to aromatic polyisocyanates being 4:1 to 1:4.

In a further preferred embodiment, the preparation of the polyurethanes, which have at least one structural element of the formula I, takes place by reacting the sulfonic acid compounds according to the invention with polymers carrying isocyanate groups.

Such isocyanate-carrying polymers can be obtained, for example, by reacting diisocyanates with diols and optionally further compounds which have groups reactive toward polyisocyanates. Suitable as diols are, for example, relatively high molecular weight diols which have a molecular weight of from about 500 to about 5000, for example from about 1000 to about 3000 g/mol. Suitable as diols are, in particular, the polyesters, polycarbonates or polylactones already listed above, or mixtures of two or more thereof, provided that they have at least two OH groups.

Also suitable as diols are polyether diols, as are obtainable by polyaddition of ethylene oxide, propylene oxide, butylene oxide, tetrahydrofuran, styrene oxide or epichlorohydrin with themselves, e.g. in the presence of basic catalysts or by the addition of these compounds, optionally in a mixture or one after the other, to starting components having reactive hydrogen atoms. The reaction is carried out as described above. Said diols can also be used in a mixture of two or more of said compounds.

In the preparation of such isocyanate-carrying polymers it is also possible to use low molecular weight diols in secondary amounts. Suitable low molecular weight diols have already been described above within this text.

In a preferred embodiment of the invention, use is made of diisocyanate-carrying polymers which have been reacted using polyester diols or polyether diols or a mixture thereof, optionally together with low molecular weight diols, by reaction with polyisocyanates to give isocyanate-carrying polyurethane prepolymers. The proportion of polyether diols in such polyurethane prepolymers is, for example, about 10 to about 100 mol %, and the proportion of low molecular weight diols, based on the total amount of diols present in the polyurethane prepolymer, is about 0 to about 90 mol %. In a preferred embodiment of the present invention, the ratio of the polyether diols to the low molecular weight diols is about 0.2:1 to 5:1, for example about 0.5:1 to about 2:1.

As well as having the structural elements of the formula I originating from the sulfonic acid compounds according to the invention, the polyurethanes according to the invention can also have further anionic or cationic groups.

For the purposes of the present invention, “anionic” or “cationic” groups are understood as meaning groups which can be converted into ionic hydrophilic groups by simple neutralization, hydrolysis or quaternization reactions. Examples of such groups are carboxylic acid groups, anhydride groups or tertiary amino groups.

Compounds suitable for the introduction of anionic or cationic groups are, for example, tris(hydroxyalkyl)amines, N,N′-bis(hydroxyalkyl)alkylamines, N-hydroxyalkyldialkylamines, tris(aminoalkyl)amines, N,N′-bis(amino-alkyl)alkylamines, N-aminoalkyldialkylamines, the alkyl radicals and alkanediyl units of these tertiary amines having, independently of one another, about 2 to about 6 carbon atoms. Said tertiary amines can be converted to the corresponding ammonium salts, for example, with acids, preferably with strong mineral acids, such as phosphoric acids, sulfuric acid, hydrohalic acid, or strong organic acids or by reaction with suitable quaternizing agents, such as C₁ to C₆-alkyl halides, e.g. bromides, chlorides or iodides. To introduce anionic groups into the polyurethane, aliphatic, cycloaliphatic, araliphatic or aromatic carboxylic acids which have at least one OH group or at least one primary or secondary amino group are usually suitable. Preference is given to dihydroxyalkylcarboxylic acids, in particular to those which have about 3 to about 10 carbon atoms. Such compounds are described, for example, in U.S. Pat. No. 3,412,054.

Likewise suitable are corresponding dihydroxysulfonic acids and dihydroxyphosphonic acids, such as 2,3-dihydroxypropanephosphonic acid. Moreover, dihydroxy compounds which have a molecular weight of about 500 to about 10 000 g/mol and have at least two carboxyl groups are suitable. Compounds of this type are disclosed, for example, in DE-A 3 911 827.

If monomers with ionic groups are used in the preparation of the polyurethanes according to the invention or in the preparation of the polyurethane prepolymers described above, they can be converted to the ionic form before, during or after the polyaddition.

In the preparation of the polyurethanes according to the invention, as well as the compounds already mentioned, it is possible for further compounds to be additionally present which serve for the crosslinking or a chain extension. These compounds are generally aliphatic or cycloaliphatic alcohols, amines having two or more primary or secondary amino groups, and compounds which, in addition to one or more OH groups, carry one or more primary or secondary amino groups. Also suitable are compounds which have a mixture of two or more of the abovementioned functional groups.

Polyamines having two or more primary or secondary amino groups or a mixture of these groups are used primarily when a chain extension or crosslinking is to take place in the presence of water since amines generally react with polyisocyanates more quickly than alcohols or water. This is, then, frequently necessary if aqueous dispersions of crosslinked polyurethanes or of polyurethanes with a high molecular weight are desired.

Amines suitable for this purpose are generally polyfunctional amines having a molecular weight of from about 32 to about 500 g/mol, preferably from about 60 to about 300 g/mol, which have at least two primary, two secondary or one primary and one secondary amino group. For the purposes of the present text, suitable amines are specified above. Where appropriate, in the preparation of the polyurethanes according to the invention, further compounds may be present in the reaction mixture which result in the crosslinking or branching of the polyurethane molecules which form. These include, for example, alcohols having more than two OH groups, such as trimethylolpropane, triethylolpropane, glycerol, pentaerythritol or the group of sugars, for example glucose, sorbitol or mannitol or oligomeric sugars, such as sucrose, maltose or dextrose. For the same purpose in the reaction it is also possible to use polyisocyanates which have more than two isocyanate groups. Suitable compounds are, for example, isocyanurates or biuret compounds, as can be prepared, for example, by appropriate reaction of hexamethylene diisocyanate.

Additionally, in the reaction to give the polyurethanes according to the invention compounds may also be present in the reaction mixture which are monofunctional toward the functional groups present in the reaction mixture. These include, for example, monoisocyanates, monoalcohols and monoprimary or -secondary amines. The proportion of such compounds in the overall reaction mixture is generally at most 10 mol %, based on the total amount of starting materials. Such monofunctional compounds generally carry further functional groups, such as olefinically unsaturated groups or carboxyl groups and serve for their introduction into the polyurethane. Said functional groups then permit a further, polymer-analogous reaction of the polyurethane. Suitable monomers are, for example, isopropyl α,α-dimethylbenzyl diisocyanate (TMI) or esters of acrylic or methacrylic acid, such as hydroxyethyl acrylate or hydroxyethyl methacrylate.

The individual components are used in amounts such that a correspondingly desired molecular weight is obtained. The choice of quantitative ratios of the individual components to one another and the molecular weight resulting therefrom is made in accordance with the general principles of polyurethane chemistry. In a preferred embodiment of the present invention, the starting materials used for the preparation of the polyurethane according to the invention are therefore used in an amount such that the ratio of isocyanate groups to groups reactive toward polyisocyanates is about 0.5:1 to about 2:1, preferably about 0.8:1 to 1.5:1 or about 0.9:1 to about 1.2:1 or about 1:1.

The molecular weight of the polymers according to the invention which have at least one structural unit of the formula IV or IVa is generally about 3000 to about 5 000 000 g/mol, for example about 4000 to about 1 000 000 or about 10 000 to about 100 000, depending on the desired field of application.

The polymers according to the invention may have only one structural unit of the formula IV or IVa, although it is equally possible for a polymer according to the invention to have two or more structural units of the formula IV or IVa. In a preferred embodiment of the invention, the polyurethane according to the invention has about 1 to about 1000, preferably about 1 to about 500, in particular about 2 to about 100, structural units of the formula IV or IVa.

In a further embodiment of the present invention, the polyurethanes according to the invention are thermoplastic polyurethanes, for example thermoplastic block copolyurethanes.

In another embodiment according to the invention constructed as a block copolyurethane and has at least one hard segment and at least one soft segment. It is preferred that a block copolyurethane according to the invention has a structural unit of the general formula IV or IVa in the hard segment.

The preparation of the polyurethanes according to the invention is generally carried out in a solvent or solvent-free, for example in the melt. Suitable solvents are, for example, acetone, methyl ethyl ketone or cyclic ethers, such as tetrahydrofuran or dioxane, and cyclic ketones, such as cyclohexanone. Likewise suitable are, depending on the field of application of the polyurethanes, also other strongly polar solvents, such as dimethylformamide, N-methylpyrrolidone, dimethyl sulfoxide or ethylene glycol acetate. Said solvents may, where appropriate, be mixed with aromatic compounds, such as toluene or xylene, or with esters, such as ethyl acetate or butyl acetate. Where appropriate, catalysts may also be present in the preparation. Suitable catalysts are tertiary amines, such as triethylamine, triethylenediamine, N-methylpyridine or N-methylmorpholine, metal salts, such as tin octoate, lead octoate or zinc stearate, or organometallic compounds, such as dibutyltin dilaurate. The suitable amount of catalyst is dependent on the effectiveness of the catalyst in question. In general, it has proven expedient to use about 0.005 to about 0.3 parts by weight for each 100 parts by weight of polyurethane.

The compounds of the formula I according to the invention, and the polyaddition or polycondensation products prepared using the compounds according to the invention are suitable, for example, for the preparation of aqueous dispersions, in particular of stable aqueous dispersions.

If compounds of the formula I or polyaddition or polycondensation products prepared therefrom are used as dispersion auxiliaries, then aqueous dispersions can, for example, be obtained therefrom which have excellent long-term stability. Depending on the intended use of the dispersions which are obtainable, the proportion of compounds of the formula I or of polyaddition and polycondensation products prepared therefrom in the overall aqueous dispersion can vary within wide limits. If the compounds according to the invention are used, for example, as dispersants for the stabilization of a dispersion which comprises a non-self-dispersing solid, then the use amount of the compounds according to the invention can be within a range from about 0.01 to about 40% by weight, for example about 0.1 to about 20% by weight or about 0.5 to about 10% by weight or about 1 to about 5% by weight. The proportion of solids in such a dispersion can vary over a wide range. Depending on the intended use, the compounds according to the invention can be used to give dispersions which have a solids content of up to about 99% by weight. Particularly when such dispersions are to be used for the coating of surfaces, they preferably have a solids content of about 30 to about 95% by weight, for example about 40 to about 90% by weight or about 50 to about 80% by weight.

The present invention therefore also provides aqueous dispersions comprising at least one sulfonic acid compound according to the invention.

In a further preferred embodiment, the compounds according to the invention are, however, also suitable as the sole constituent of such a dispersion, in particular as the discontinuous phase of an aqueous dispersion. Dispersions of this type can be used, for example, as coating compositions for the production of surface coatings. Within the scope of such a use, it is advantageous to use, as the compound according to the invention, a compound which, following removal of the continuous phase, produces a surface coating which corresponds to the wishes of the user. Within the scope of such a use, it is therefore preferred according to the invention if the compound according to the invention which is used is a compound having a molecular weight of at least about 1000.

For the purposes of the present invention, particular preference is given to those aqueous dispersions which have at least one of the abovementioned polyaddition or polycondensation products according to the invention, in particular at least one of the polyurethanes according to the invention. In a preferred embodiment of the invention the aqueous dispersion comprisis at least 20% by weight of a polyurethane according to the invention.

The aqueous dispersions according to the invention can, as well as water and one of the abovementioned compounds according to the invention, or a mixture of two or more thereof, also comprise one or more further compounds.

If the aqueous dispersion according to the invention is to be used as a surface coating composition, then the dispersion may, for example, comprise at least one polymer obtainable by polymerizations of monomers having ethylenically unsaturated double bonds. Suitable monomers are, for example, acrylic acid, methacrylic acid, acrylonitrile, acrylic esters or methacrylic esters, as are obtainable by esterification of acrylic acid or methacrylic acid with methanol, ethanol, n-butanol, isobutanol or 2-ethylhexyl alcohol, vinyl esters of carboxylic acids having 1 to 16 carbon atoms or 1-alkenes, such as ethylene, propylene, butylene or styrene. Polymers of this type can be added to the dispersion according to the invention, for example, already in dispersed or at least polymerized form. It is, however, likewise possible to prepare said polymers in the aqueous dispersion according to the invention. In this connection, the respective compounds and reaction conditions may be chosen such that, for example, at least some of the polymers generated in the dispersion are added to the compounds according to the invention present in the dispersion in the sense of a graft reaction. The preparation of corresponding polymers is carried out by methods known to the person skilled in the art, as are described, for example, in D. C. Blackley, Emulsion polymerization—Theory and Practice, London, Applied Science Publishers, 1975 or in H. Warson, Application of Synthetic Resin Emulsions, London, Benn Publishers, 1972 or in I. Piirma, Emulsion polymerization, New York, Academic Press Inc., 1982.

The compounds according to the invention may further comprise additives, such as organic solvents, pigments, dyes, emulsifiers, surfactants, thickeners, stabilizers, flow-control agents, fillers, sedimentation inhibitors, flame retardants, UV stabilizers or antioxidants.

Suitable solvents are, for example, acetone, methyl ethyl ketone, tetrahydrofuran, dimethylformamide, dimethylacetamide, dioxane, ethyl acetate and the like, or a mixture of two or more thereof. The dispersions according to the invention may comprise the organic solvents in an amount of up to about 20% by weight, preferably up to about 10% by weight.

Suitable thickeners are, for example, polymers of hydrophilic, free-radically polymerizable monomers, such as acrylic acid, methacrylic acid, polyvinyl-pyrrolidone or thickeners based on cellulose or starch derivatives, such as carboxymethylcellulose, carboxyethylcellulose, hydroxyethylcellulose, hydroxypropylcellulose, hydroxyethyl starch, hydroxypropyl starch and the like. Said thickeners may in each case be present individually or as a mixture of two or more thereof in the dispersions according to the invention.

Suitable fillers or pigments are, for example, titanium dioxide, antimony oxide, zinc oxide, basic lead carbonate, basic lead sulfate, barium carbonate, porcelain powder, clay, aluminum silicate, silica, magnesium carbonate, magnesium silicate or calcium carbonate. Colored pigments which may be used are, for example, cadmium yellow, cadmium red, carbon black, phthalocyanine blue, chromium yellow, toluidine red and hydrated iron oxide.

The dispersions according to the invention are prepared in accordance with generally customary methods known to the person skilled in the art. Suitable methods are described in Kunststoffhandbuch [Plastics handbook], No. 7, Polyurethane, Karl Hanser Verlag, 1993.

The aqueous dispersions according to the invention can be used, in particular, as surface coating compositions. In this respect, they may be combined with a large number of substrates. Examples of suitable substrates are wood, metal, glass, textiles, leather, paper, plastics and the like. The aqueous dispersions according to the invention can be applied by any desired conventional methods, such as dipping, spraying, knife coating, brush application or the like.

The present invention further relates to the use of a compound of the formula I or of a polyaddition or polycondensation compound which has a structural unit of the formula IV or IVa as wetting agent, dispersion auxiliary, surfactant, adhesion promoter, auxiliary in electroplating baths, acid catalyst in chemical syntheses or as hardening component in coating compositions.

The invention is explained in more detail below using examples.

### EXAMPLES

### Example 1

106 g of isopropanol and 158 g of 2-(2-aminoethoxy)ethanol (1.5 mol) were introduced into a stirred flask fitted with temperature control facility, thermometer and feed vessel, and maintained at reflux temperature. Over a period of about 30 min, a clear solution of 310 g of 2-acrylamido-2-methylpropanesulfonic acid (1.5 mol), 151.8 g of triethylamine in 360 g of isopropanol was added to this mixture. The reaction mixture was stirred for a further 60 min at this temperature and then allowed to cool. The reaction product was referred to as precursor 1.

360 g of precursor 1 were initially introduced, and a solution of 42 g of hexamethylene diisocyanate in 42 g of acetone was added at room temperature with stirring over the course of 30 minutes. A slightly exothermic reaction resulted.

The mixture was then stirred for a period of about 20 minutes at 60° C. The resulting solution was concentrated under reduced pressure on a rotary evaporator, giving a gradually crystallizing oily substance. The main constituent, identified by H-NMR analysis, was the structure below (Formula Ic):

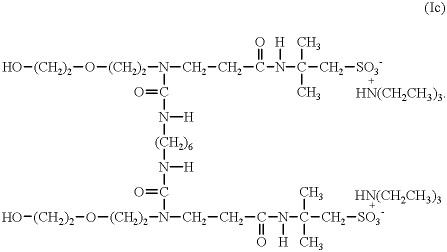

### Example 2

106 g of isopropanol and 158 g of 2-(2-aminoethoxy)ethanol (1.5 mol) were introduced into a stirred flask fitted with temperature control facility, thermometer and feed vessel, and maintained at reflux temperature. Over a period of about 30 min, a clear solution of 310 g of 2-acrylamido-2-methylpropanesulfonic acid (1.5 mol), 60 g of sodium hydroxide in a mixture of 200 g of isopropanol and 200 g of water was added dropwise to this mixture. The reaction mixture was stirred for a further 60 min at this temperature and then allowed to cool. The reaction product was referred to as precursor 1.

345 g of precursor 1 were initially introduced, and a solution of 42 g of hexamethylene diisocyanate in 42 g of acetone was added at room temperature with stirring over the course of 30 minutes. A slightly exothermic reaction resulted. The mixture was then stirred for a period of about 20 minutes at 60° C. The resulting solution was concentrated under reduced pressure on a rotary evaporator, giving a gradually crystallizing oily substance. The main constituent, identified by H-NMR analysis, was the structure below (Formula Id):

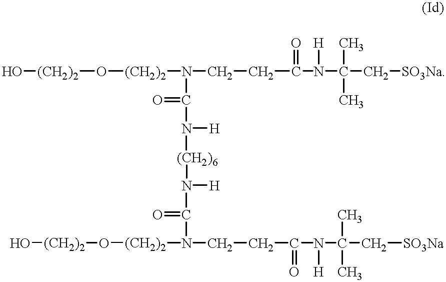

### Example 3

A stirred apparatus was charged with 103.5 g (0.5 mol) of 2-acrylamido-2-methylpropanesulfonic acid and 0.5 g of 4-methoxyphenol in 100 g of water. 20 g (0.5 mol) of sodium hydroxide in 60 g of water were then added dropwise at a maximum of 30° C. Following the addition of 52.65 g (0.45 mol) of 6-amino-1-hexanol in 60 g of water, the mixture was heated for 8 hours at below 20° C. (bath temperature). After the mixture had been cooled to room temperature, it was neutralized with 49.3 g (0.5 mol) of concentrated hydrochloric acid. Following removal of the solvent, the residue was dissolved in 53 g of warm ethanol, and sodium chloride which precipitated out was filtered off. Removal of the solvent gave the product as a brown, high-viscosity liquid.

### Example 4

Prepolymer with a Michael Adduct of 6-amino-1-hexanol and 2-acrylamido-2-methylpropanesulfonic Acid

75 g (0.3 mol) of 4,4′-diphenylmethane diisocyanate, 32 g (0.2 mol) of 2-butyl-2-ethyl-1,3-propanediol and 0.02 g of dibutyltin dilaurate as catalyst were introduced into 107.0 g of tetrahydrofuran and reacted at 60° C. The reaction was carried out until the NCO content of 11.78% had dropped to 3.93%. 64.8 g (0.2 mol) of the Michael adduct from Example 3 were then added to 60 g of tetrahydrofuran, and the mixture was heated at 80° C. until the reaction had proceeded to completion. This gave a brownish cloudy solution of high viscosity.

### Example 5

Prepolymer with Polypropylene Glycol and a Michael Adduct of 6-amino-1-hexanol and 2-acrylamido-2-methylpropanesulfonic Acid

13.3 g (0.06 mol) of isophorone diisocyanate, 18 g (0.03 mol) of propylene glycol (molecular weight: 600) and 0.02 g of dibutyltin dilaurate as catalyst were introduced into 47 g of a mixture of dimethylformamide and tetrahydrofuran in the ratio 1:1.4 and heated to 80° C. The NCO content decreased during this time from 6.44% to 3.22%. A solution of 19.4 g (0.06 mol) of a Michael adduct (Example 3), dissolved in 30 g of a mixture of dimethylformamide and tetrahydrofuran in the ratio 1:1.4, was then added. The mixture was further stirred at 80° C. until the NCO content had dropped to 0%. Clouding which occurred during the reaction was removed by the addition of 10 g of dimethylformamide.

### Example 6

Preparation of a Polymer in the Melt

137.5 g (0.25 mol) of CAPA 200 (polycaprolactonediol), 29.5 g (0.25 mol) of hexanediol, 53 g (0.25 mol) of AMPS and 0.5 g of TEMPOL (polymerization inhibitor) were stirred at 100° C. Over the course of 10 min, 25 g of triethylamine were added dropwise at 100° C. After stirring for a further 10 min the mixture became clear. Then, at 80° C., 15.25 g (0.25 mol) of ethanolamine were added dropwise over the course of 15 min, the mixture subsequently being stirred for a further 60 min at 80° C. Thereafter, 333 g (1.5 mol) of isophorone diisocyanate were added dropwise over the course of 20 min. Cooling gave a sulfonic-acid-modified polyurethane as a wax-like solid.

### Example 7

100 g of methyl ethyl ketone, 1100 g of polycaprolactone (CAPA 200, 1.0 mol), 208 g of 2-acrylamido-2-methylpropanesulfonic acid (AMPS, 1.0 mol) and 0.5 g of hydroquinone monomethyl ether were heated to 60° C. with stirring in a stirred flask fitted with thermometer and feed vessel. A cloudy suspension formed, into which 190 g of tributylamine (1 mol +5 g) were added dropwise with vigorous stirring over the course of 20 minutes. The reaction preceded exothermally, and the temperature increased to about 80° C. The reaction mixture was maintained at this temperature for 20 minutes. A slightly cloudy solution formed, into which 150 g of diethanolamine (1 mol) were added dropwise at about 80° C. The reaction mixture was stirred for about another hour under reflux. 1 g of dibutyltin dilaurate was then added, and then, under reflux, 336 g of hexamethylene diisocyanate (2 mol) were slowly added dropwise over the course of about 20 minutes. When the exothermic reaction was complete, the mixture was maintained at 80° C. for a further hour. This gave a slightly cloudy viscous solution of an oligomeric urethane compound which had sulfonic acid/tributylamine salt groups and terminal OH groups in random distribution. The solution could be diluted with water as required.

### Example 8

103.5 g (0.5 mol) of 2-acrylamido-2-methylpropanesulfonic acid and 0.5 g of 4-methoxyphenol were dissolved in 100 g of water in a stirred apparatus. 20 g (0.5 mol) of sodium hydroxide, dissolved in 60 g of water, were then added dropwise at at most 30° C. 59.85 g (0.45 mol) of diisopropanolamine and 60 g of water were then added, and the mixture was heated to 20° C. After a reaction time of 8 hours, the mixture was cooled to room temperature and neutralized with 49.3 g (0.5 mol) of concentrated hydrochloric acid. The solvent was then removed, and the residue was dissolved in 53 g of warm ethanol. The sodium hydroxide which precipitated out during the process was separated off. The filtrate crystallized out upon cooling.

### Example 9

17.0 g of the Michael adduct from Example 7 were reacted with 66.6 g (0.3 mol) of isophorone diisocyanate and 0.5 g of dibutyltin dilaurate in 31 g of N-methylpyrrolidone at 100° C. with stirring. When the solution had reached an NCO content of 9.83%, 48.0 g (0.3 mol) of 2-butyl-2-ethyl-1,3-propanediol and 0.1 g of dibutyltin dilaurate were added. The reaction mixture was held at 100° C. until the end of the reaction. The process gave a product which, following removal of the solvent, was soluble in tetrahydrofuran, toluene and methanol.

### Example 10

Preparation of a Polyurethane Dispersion

Preparation of the Michael adduct:

227.7 g (1.1 mol) of acrylamido-2-methylpropanesulfonic acid (AMPS) and 1.0 g of hydroquinone monomethyl ether were dissolved in 200 g of water. Then, with ice cooling, a solution of 44.2 g (1.1 mol) of sodium hydroxide in 150 g of water was added at a rate such that the temperature did not exceed 30° C. Then, 118 g (1.0 mol) of diisopropanolamine, dissolved in 50 g of water, were added, and the mixture was stirred for 8 hours at 120° C. This gave a clear reaction solution with a slightly yellowish coloration.

To exactly determine the amount of hydrochloric acid required for the neutralization, a sample of the reaction solution was titrated with 1 m HCl. The equivalent amount of HCl (37% strength) calculated for the entire mixture was slowly added. The water was then distilled off until a viscous sludge formed. This was dissolved warm in 700 ml of ethanol. The NaCl which precipitated out was filtered off. Upon cooling the filtrate, the end product slowly crystallized out.

Preparation of the polyurethane dispersion:

27.9 g (0.0894 mol) of the Michael adduct, 70 g of N-methylpyrrolidone and 133 g (0.0665 mol) of a polyester polyol of adipic acid, 1,6-hexanediol and neopentyl glycol having an OH number of 56 were introduced into a stirred flask.

At 50° C., 42 g (0.1889 mol) of isophorone diisocyanate and 0.2 ml of dibutyltin dilaurate were added to this mixture, and the mixture was stirred for 60 minutes at 80° C. The mixture was then diluted with 200 g of acetone, neutralized with 8.6 g (0.085 mol) of triethylamine and dispersed by adding 530 g of water. Distilling off the acetone gave a finely divided, stable polyurethane dispersion having a solids content of 40% by weight.

We claim:

1. A sulfonic acid compound of the formula I 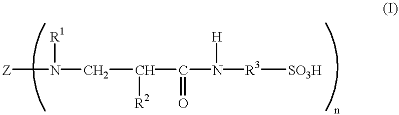
wherein it 1<n≦2, at least one of the radicals R¹ is R⁴—QH, R⁴—Q—(X—O—)ₘX—QH or R⁴—O—Y—QH, where Q is O (oxygen), NH, NR² or S, R⁴ is a linear or branched, saturated or unsaturated alkyl radical having 2 to 44 carbon atoms, X is an optionally aromatically substituted alkyl radical having 2 to 14 carbon atoms, Y is a polyester, a polyamide, a polycarbonate, a polyurethane or a polylactone having a molecular weight M_{w} of from 150 to 5000, and m is a value from 1 to 300, the radicals R², independently of one another, are in each case H or a linear or branched, saturated or unsaturated aliphatic hydrocarbon radical having 1 to about 20 carbon atoms, a saturated or unsaturated, optionally substituted cycloaliphatic hydrocarbon radical having 4 to about 20 carbon atoms, an optionally substituted aliphatic hydrocarbon radical having 6 to about 20 carbon atoms or an optionally substituted aromatic hydrocarbon radical having 6 to 18 carbon atoms, the radicals R³ are a linear or branched, saturated or unsaturated alkyl radical having 2 to 44 carbon atoms or a saturated or unsaturated cycloalkyl radical having 6 to 44 carbon atoms, Z is a linear or branched, saturated or unsaturated optionally substituted alkyl radical having 8 to 44 carbon atoms, an optionally substituted cycloalkyl radical having 4 to 44 carbon atoms, an optionally substituted araliphatic hydrocarbon radical having 6 to 40 carbon atoms or a polyether, a polyester, a polyamide, a polycarbonate, a polyurethane or a polylactone having a molecular weight M_{w} of from 150 to 10 000, where Z is bonded to the whole molecule via suitable functional groups, or a partial or complete salt thereof, and if n is a number of more than 2 to 100 000, the radicals R¹, in each case independently of one another, are H, CH₃, a linear or branched, saturated or unsaturated alkyl radical having 2 to 44 carbon atoms or a cycloalkyl radical having 4 to 44 carbon atoms or an aromatic hydrocarbon radical having 6 to 10 carbon atoms, R⁴—QH, R⁴—Q—(X—O—)ₘX—QH or R⁴—O—Y—QH, where Q is O, NH, NR² or S, R⁴ is a linear or branched, saturated or unsaturated alkyl radical having 1 to 44 carbon atoms, and X, Y, m, R², R³ and Z have the meanings given above, and if n is 1, R² is H or a linear or branched, saturated or unsaturated aliphatic hydrocarbon radical having 1 to 20 carbon atoms, a saturated or unsaturated, optionally substituted cycloaliphatic hydrocarbon radical having 4 to 20 carbon atoms or an optionally substituted araliphatic hydrocarbon radical having 6 to 40 carbon 10 atoms, R³ is a linear or branched, saturated or unsaturated aliphatic hydrocarbon radical having 1 to 20 carbon atoms or a cycloaliphatic hydrocarbon radical having 4 to 20 carbon atoms or an optionally substituted aromatic hydrocarbon having 6 to 18 carbon atoms, R¹ and Z, in each case independently of one another, are R⁴—QH, R⁴—Q—(X—O—)ₘX—QH or R⁴—O—Y—QH, where Q is O (oxygen), NH, NRe or S, R⁴ is a linear or branched, saturated or unsaturated, optionally aromatically substituted alkyl radical having 2 to 44 carbon atoms, X is an optionally aromatically substituted alkyl radical having 2 to 14 carbon atoms, Y is a polymer, obtainable by polymerization, polyaddition or polycondensation, having a molecular weight M_{w} of from 150 to 5000 and m is a value from 1 to 300 and where the two radicals R¹ and Z are not CH₂—CH₂—OH at the same time, or a salt thereof.

2. A sulfonic acid compound as claimed in claim 1, having one or more of the following features:
one of the radicals R² is H or CH₃,
at least one the radicals R³ is a linear or branched aliphatic hydrocarbon radical having 3 to 8 carbon atoms,
n is a number from 1,8 to 2.

3. A sulfonic acid compound as claimed in claim 1, having one or more of the following features:
one of the radicals R² is H or CH₃,
at least one of the radicals R³ is a linear or branched aliphatic hydrocarbon radical having 3 to 8 atoms,
n is a number from more than 2 to 6.

4. A sulfonic acid compound as claimed in claim 1, having one or more of the following features:
R² is H or CH₃,
R³ is a linear or branched aliphatic hydrocarbon radical having 3 to 8 carbon atoms,
R⁴ is a linear or branched alkyl radical having 2 to 44 carbon atoms,
X is CH₂—CH₂ or CH(CH₃)—CH₂ or CH₂—CH(CH₃),
Y is an aliphatic polyester having a molecular weight M_{w} of from 150to 300and
m is a value from 1 to 200.

5. A polyaddition product or polycondensation product having at least one structural unit of the formula IV 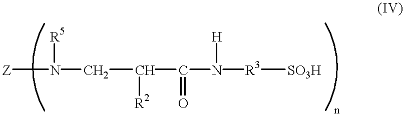
in which n is a number from 1 to 1 000 000, the radicals R⁵, independently of one another, are R⁴—O, R⁴—Q—(X—O)ₘX—Q—, R⁴—O—Y—O, where Q, R⁴, X, Y, m, R², R³ and Z have the meanings given in claim 1, or a half-salt or complete salt thereof, or a structural unit of the formula IVa.

6. A polyaddition product as claimed in claim 5, which is a polyurethane.

7. A polyaddition product as claimed in claim 5, which is constructed as a block copolyurethane and has at least one hard segment and at least one soft segment.

8. A polyurethane which has the structural unit according to claim 5 in the hard segment.

9. A process for the preparation of a polyaddition or polycondensation product according to claim 5, which comprises reacting, under suitable reaction conditions, a compound of the formula I, in which R¹, R², R³ and Z are as defined in claim 1, and a compound or a mixture of two or more compounds which are able to react together with the compound of the formula I to give a polyaddition or polycondensation product.

10. A process for the preparation of a sulfonic acid compound as claimed in claim 1, which comprises reacting a compound of the formula II
R¹—NH—Z³ (II)
in which Z³ is H or Z, R¹ and Z, in each case independently of one another, are R⁴—Q—, R⁴—Q—(X—O)ₘX—Q— or R⁴—O—Y—Q—, where Q is O (oxygen), NH, NR⁴ or S, R⁴ is a linear or branched, saturated or unsaturated, optionally aromatically substituted alkyl radical having 2 to 44 carbon atoms, X is an optionally aromatically substituted alkyl radical having 2 to 14 carbon atoms, Y is a polymer, obtainable by polymerization, polyaddition or polycondensation and having a molecular weight M_{w} of from 150 to 5000, and m is a value from 1 to 300, and where the two radicals R¹ and Z are not CH₂—CH₂—OH at the same time, and a compound of the formula III 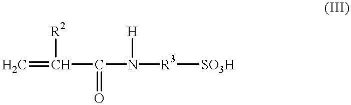
together in the sense of a Michael addition.

11. The method of using a sulfonic acid compound according to claim 1 for the preparation of polyaddition or polycondensation products.

12. The method of using a sulfonic acid compound according to claim 1 for the preparation of polyaddition or polycondensation products, wherein the polyaddition and polycondensation products are polyurethanes, polyesters, polyethers, polycarbonates, polyether esters, polyamides, polyester amides, polyether amides, polylactones or polylactams.

13. The method of using sulfonic acid compounds according to claim 1, as wetting agent, dispersion auxiliary, surfactant, adhesion promoter, auxiliary in electroplating baths, acid catalyst in chemical syntheses or as a hardening component in coating compositions.

14. The method of using polyaddition or polycondensation compounds according to claim 5 as wetting agent, dispersion auxiliary, surfactant, adhesion promoter, auxiliary in electroplating baths, acid catalyst in chemical syntheses or as a hardening component in coating compositions.

15. An aqueous dispersion comprising at least one sulfonic acid compound according to claim 1.

16. An aqueous dispersion comprising at least one polyaddition or polycondensation compound according to claim 5.

17. An aqueous dispersion, which comprises at least 20% by weight of a polyaddition or polycondensation compound according to claim 5, especially of a polyurethane.
